(19) United States
(12) Patent Application Publication
(10) Pub. No.: US 2010/0263764 A1
(43) Pub. Date: Oct. 21, 2010

(54) Spill curtailing tool

(76) Inventor: Glenn Cox, Cornwall (CA)

Correspondence Address: MARIO D. THERIAULT, 812 HWY. 101 NASONWORTH, FREDERICTON, NB, E3C 2B5, CA

(21) Appl. No.: 12/662,319

(22) Filed: Apr. 12, 2010

Related U.S. Application Data
(60) Provisional application No. 61/202,902, filed on Apr. 17, 2009.

(51) Int. Cl. B65B 3/04; B29C 31/04; F16L 55/18; B65D 85/00; B29B 15/00

(52) U.S. Cl. 141/313; 138/93; 138/97; 206/524; 220/287; 425/11; 141/10; 114/227

(57) ABSTRACT

The spill curtailing tool has an elongated expandable frame; a first handle on a first end of the frame; a second handle mounted to an intermediate position along the frame, and a tube mounted to a second end of the elongated frame. The second end of the frame supporting the tube is telescopically movable toward and away from the first and second handles. A pair of pressurized instant-foam-producing tanks are mounted to the elongated telescoping frame between the first and second handles. The tanks are connected by hoses to the tube for delivering instant foam through the tube. A folded bladder is mounted over the tube for receiving instant foam therein. The tube is angularly movable relative to a plane of the elongated frame, such that it can be pointed in different directions relative to a plane of the elongated frame.

### FIELD OF THE INVENTION

This invention pertains to hand tools for sealing a perforation in a fluid reservoir to quickly curtail a spill from that reservoir, and more particularly, it pertains to hand tools for inserting and inflating a bladder in a perforation through the wall of a fluid reservoir for temporary sealing the perforation.

### BACKGROUND OF THE INVENTION

Perforation plugging devices are well known in the marine industry especially for making emergency repairs to the hulls of floating vessels. Perforation and breach plugging devices are also used for quickly plugging holes in containers of hazardous materials.

The following examples of breach plugging devices provide a good sampling of the inventory of plugging tools available in the prior art;

U.S. Pat. No. 1,301,204 issued to P. C. Warner et al. on Apr. 22, 1919;
U.S. Pat. No. 2,446,190 issued to C. A. Oding on Aug. 3, 1948;
U.S. Pat. No. 3,866,560 issued to J. Steward on Feb. 18, 1975;
U.S. Pat. No. 4,012,822 issued to J. J. Vrolyk et al. on Mar. 22, 1977;
U.S. Pat. No. 4,329,132 issued to R. W. Melvold et al. on May 11, 1982;
U.S. Pat. No. 4,390,333 issued to M. A. J. Dubois on Jun. 28, 1983;
U.S. Pat. No. 4,892,219 issued to R. W. Smith on Jan. 9, 1990;
U.S. Pat. No. 5,245,941 issued to P. Gattuso on Sep. 21, 1993;
U.S. Pat. No. 6,058,870 issued to J. E. Conley on May 9, 2000;
U.S. Pat. No. 6,467,421 issued to J. E. Conley on Oct. 22, 2002;
U.S. Pat. No. 6,543,486 issued to J. H. Morris on Apr. 8, 2003;
U.S. Pat. No. 6,722,304 issued to J. E. Conley on Apr. 20, 2004;
DE Patent 019618761, filed by U. Schleicher, published on Nov. 12, 1997;
GB Patent Appl. WO 01/16518, filed by A. Harris, publ. on Mar. 8, 2001;
CA Patent Appl. 2,040,214, filed by G. W. Kassbaum, publ. Oct. 12, 1991;
Canadian Patent 1,103,534, issued to C. J. Hsu on Jun. 23, 1981.

Most hazardous spills occurring inland are from transport trucks involved in highway accidents and railroad cars involved in derailments. In spite of the work that has been done in the past to develop breach plugging devices for floating vessels and large stationary tanks, it is believed that the trucking industry still does not have a practical tool that can be carried in a truck's tool box and that can be easily handled without much training to stop a spill from a damaged tanker truck.

It is also believed that there is a need in the trucking industry for a tool capable of stopping a spill without exposing the user of the tool to the material escaping from a damage tanker. Because the tools of the prior art require a direct approach to a breach in a reservoir, these tools are not considered safe for use by handlers working under the stresses associated with the urgency of these situations

The reservoir on a tanker truck has a relatively thin wall as compared to the hull of a floating vessel. When a reservoir on a tanker truck is punctured by accident, the edges of the hole are relatively thin and sharp, which make it difficult to introduce and to inflate a bladder in that hole without damaging the bladder. The tools of the prior art use rubber bladders which are not practical for plugging holes in a thin metal shell, because a rubber bladder is susceptible of rupturing before it is fully inflated.

It is for these reasons primarily, that an efficient tool has not yet been introduced to the trucking industry for plugging thin shell reservoirs.

Therefore, it is believed that there is a need in the trucking industry in particular, and by environment protection agencies for a hand tool that is particularly useful to prevent hazardous spills and environmentally sensitive spills from ruptured tanker trucks, ruptured railway cars, an other reservoirs of that nature.

### SUMMARY OF THE INVENTION

The word “fluid” is used herein to designate material in liquid form, gaseous form or fluid-like substances such as powders, sand and grains.

In a first aspect of the present invention, there is provided a spill curtailing tool that has an elongated expandable frame; a first handle on a first end of the frame; a second handle mounted to an intermediate position along the frame; and a tube mounted to a second end of the elongated frame. The second end of the frame supporting the tube is movable toward and away from the first and second handles.

A pair of pressurized instant-foam-producing tanks are mounted to the elongated frame between the first and second handles. The word “tank” is used herein to designate, a cylinder, a canister or a reservoir of some type filed with commercially available instant foam. The tanks are connected to the tube by means of hoses for delivering instant foam through the tube. A folded bladder is mounted over the tube for receiving instant foam therein. The tube is angularly movable relative to a plane of the elongated frame, as seen in the accompanying drawings, such that it can be pointed in different directions relative to the plane of the elongated frame.

The principal advantages of the spill curtailing tool according to the present invention are that the tool is portable and it is workable from an offset position relative to a spill to be sealed whereby the user thereof is not exposed to the spray of the spill.

In another aspect of the present invention, the spill curtailing tool has hoses connecting the pressurized foam-producing tanks to the tube. The tool also has a tandem valve mounted along the hoses for selectively opening the hoses. In this aspect of the invention, the tandem valve is mounted to the second handle, and the second handle is mounted in a movable manner along the intermediate portion of the frame.

The expression “tandem valve” is used herein to designate any flow control mechanism capable of controlling the flow in a pair of hoses simultaneously.

In yet another aspect of the present invention, the tube has spaced-apart holes along a length thereof. The spill curtailing tool has an angularly movable crosspiece mounted to the second end of the frame, and the tube is mounted to the crosspiece such that it is angularly movable with the crosspiece.

In yet a further aspect of the present invention, the spill curtailing tool has a pair of depth gauges mounted to the crosspiece on each side of the tube respectively. These depth gauges are telescopically extendable, and are preferably pressure sensitive.

Industrial applications for this tool comprises uses in the trucking industry, firefighters equipments, emergency rescue organizations and environment protection agencies. And of course, it can be used in the marine industry or navies for stopping sea going boats and vessels from sinking. Yet another industrial application is for plugging damaged pipelines containing liquids or gases.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

A preferred embodiment of the present invention is illustrated in the accompanying drawings, in which like numerals denote like parts throughout the several views, and in which:

FIG. 1 illustrates a typical hazardous spill of fuel from an overturned tanker truck, and a preferred mode of handling the preferred spill curtailing tool;

FIG. 2 is a perspective view of the spill curtailing tool in a collapsed mode;

FIG. 3 is a perspective view of the spill curtailing tool in an extended mode;

FIG. 4 is a partial perspective view of the preferred spill curtailing tool with the bladder-support tube extending at right angle from a plane of the tool;

FIG. 5 is a perspective side view of the tube supporting a bladder in the preferred tool;

FIG. 6 is a side view of a bladder mounted in a breach in a container;

FIG. 7 is a see-through view through the bladder of the preferred tool, showing the tube of the tool extending through the breach mentioned above.

### DETAILED DESCRIPTION OF THE PREFERRED EMBODIMENT

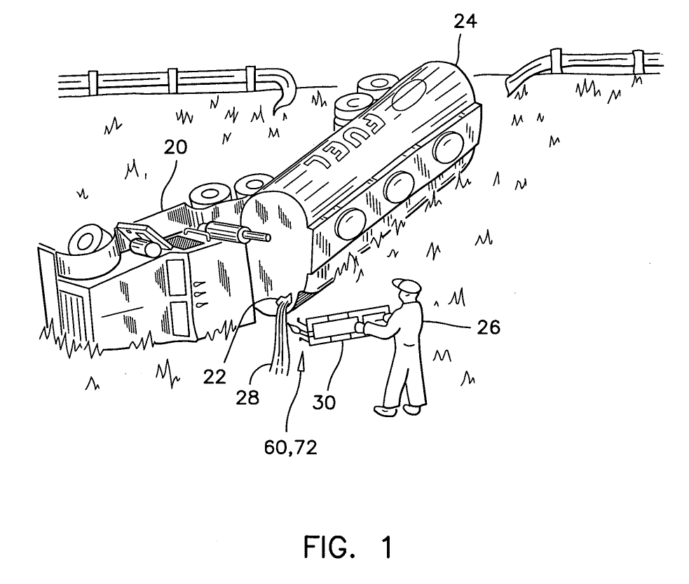

Referring back to FIG. 1, there is illustrated therein, an overturned tanker truck 20, having a perforation 22 in the front side of its tank 24. The truck operator 26 or other emergency-response personnel such as a fireman is about to plug this perforation 22 to stop the spill 28 of fluid from the perforation, using the preferred spill curtailing tool 30. FIG. 1 in particular shows a preferred mode of handling the preferred spill curtailing tool 30 such that the operator 26 is out of harms way from the spill 28.

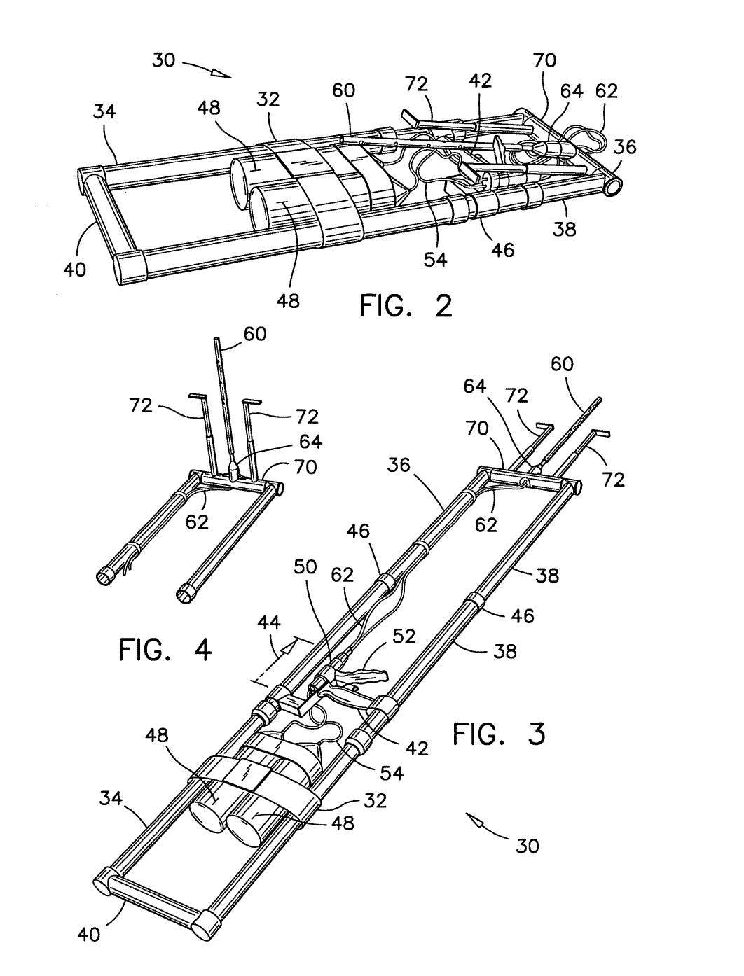

The preferred spill curtailing tool 30 is illustrated in greater details and in a collapsed and stowed mode in FIG. 2. The tool 30 has a rectangular telescopically extendable frame 32 having a non-extendable end 34 and an extendable end 36. Both sides of the frame 32, at least along the extendable end 36 are made of telescoping tubes 38.

The non-extendable end 34 of the frame 32 has a first handle 40 at a far end thereof, and a second handle 42 mounted at an intermediate position there along. The extendable frame 32 has a rectangular shape and lies and extends in a plane. The second handle 42 is adjustable along the extendable portion of the frame 36, as illustrated by arrow 44 such that an operator using the preferred tool can work at ease with the preferred tool.

The extendable portion 36 of the frame 32 can be locked in position at a certain length by means of hand nuts 46 having a knurled surface for example. The handles 40, 42 may also have knurled surfaces to offer a better hand grip.

Although the preferred embodiment has knurled nuts 46 to retain the extendable portion 36 of the preferred tool 30 to a proper position, other locking devices can be used. For example, there are friction-type; wedge-type; set-screw type and cam-lock type locking mechanisms available commercially, which would work as well in the preferred tool 30.

Although a telescoping frame has been illustrated herein, it will be appreciated that a folding frame may also be used to obtain basically the same result for extending and shortening the preferred tool.

Attached to the frame 32 between the two handles 40, 42, or to the two handles 40, 42, there are mounted two tanks 48 containing cooperatively a two-part instant foaming agent under pressure. The two-part foaming agent such as polyurethane or other commercially available instant foam is well known in the art and therefore no further explanation is deemed required.

In the preferred embodiment, a tandem valve 50 is mounted to the second handle 42 and is operated by a lever 52. The tanks 48 are connected by hoses 54 to the valve 50.

An elongated, hollow, cylindrical bladder-support tube 60 is mounted to the extendable portion 36 of the frame 32. The foaming agent from the two tanks 48 is delivered to the hollow bladder-support tube 60 via hoses 62 and through a static mixing chamber 64.

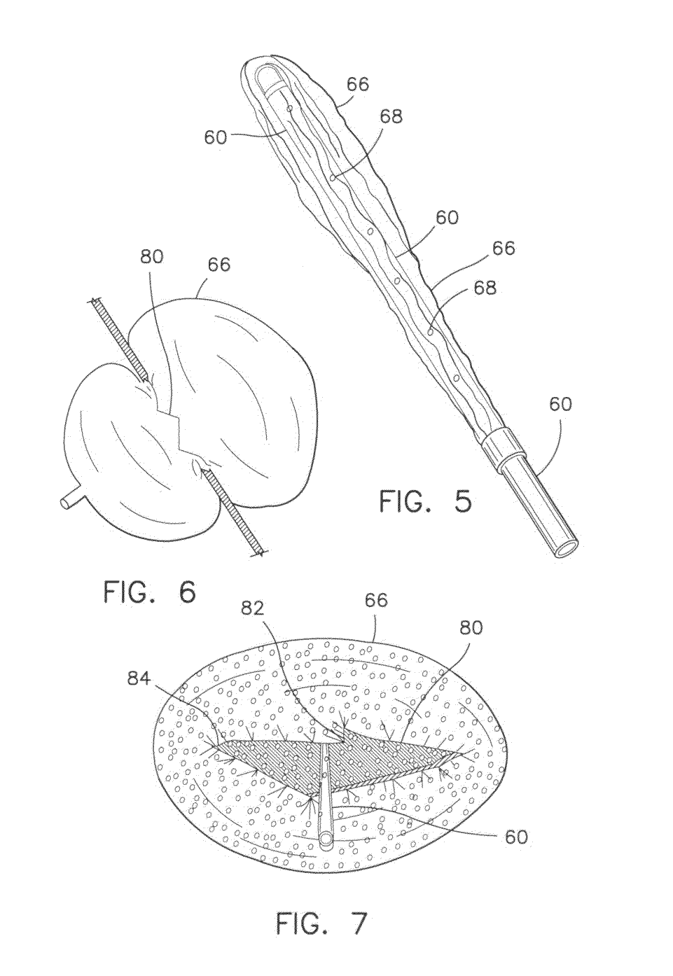

Upon the length of the tube 60 there is mounted an inflatable bladder 66, which is illustrated in FIG. 5 in a collapsed, folded mode. The folded bladder 66 is adapted to receive and to be inflated by the instant foam delivered from the tanks 48.

The static mixing chamber 64 is mounted at the base of the bladder 66, to ensure proper mixing of the foaming agent prior to reaching the bladder 66.

It will be appreciated that the bladder 66 may be wrapped tight inside an envelope that can be ripped off by the pressure of the foam filling the bladder. It will also be appreciated that the tube 60 is removably mounted to the static mixing chamber 64 such that the tube and the bladder are easily replaced after one use.

The tube 60 has spaced apart holes 68 along its length for distributing the foaming agent inside the full length of the bladder 66 and on both sides of a breach to be sealed.

Referring back to FIGS. 2-4, the base of the bladder-support tube 60 is mounted on a movable crosspiece 70. The movable crosspiece 70 lies in the same plane as the frame 32, and is articulated about an axis that is parallel to handles 40, 42. Because the bladder-support tube 60 is mounted to the crosspiece 70, the bladder-support tube 60 can be oriented angularly relative to the plane of the frame 32, as can be seen in FIG. 4.

On both sides of the bladder-support tube 60, there are provided two telescoping depth gauges 72 extending from the crosspiece 70. Both depth gauges 72 extend parallel to the bladder-support tube 60 and are movable about the crosspiece 70 in unison with the bladder-support tube 60.

The purpose of the depth gauges 72 is to support the bladder 66 from both sides of a breach to be sealed, at a proper depth in that breach. The depth gauges 72 are preferably telescopically extendable and spring loaded so that a user of the preferred tool can apply a slight pressure on the preferred tool against a breach to be sealed, and feel a bottoming of the depth gauges 72 before pulling the lever 52 on the tandem valve 50 and filling the bladder 66 with instant foam. The pressure responsive feature on the depth gauges 72 can also be effected by other devices than springs. Therefore, the expression “spring loaded” should be understood as encompassing, air-type shock absorbers, oil-type shock absorbers, elastic bumpers and devices of that nature.

It will be appreciated that when the bladder-support tube 60 is pointing away from the plane of the tool 30, such as illustrated in FIG. 4, it is relatively easy for a fireman for example to extend the bladder-support tube 60 into a perforation 22 and into a spill in progress, while standing aside or offset from the direction of the flow, as illustrated in FIG. 1 for example. This is particularly useful for plugging a hole and curtailing a spill without being exposed to the splash of the spill.

The ability to adjust the orientation of the bladder-support tube 60 relative to the plane of the tool 30 is also advantageous for introducing a plugging bladder in a work area that has a tight clearance for moving the tool or in a hole that is impossible to reach in a direct approach mode.

Yet another advantage of the preferred tool is that a boat operator can reach a breach in the hull of his boat that would be below the waterline, by extending the preferred tool to its full extension alongside the boat's hull, adjusting the tube into the breach and sealing the leak. It also can be deployed under water at depths by a diver.

FIG. 6 represents a bladder 66 that has been installed and inflated in a breach 80 in a container. The view is taken with the container seen in a cross-section mode. The view in FIG. 7 is a see-through view of the breach 80 being sealed by an expanding bladder 66. The view is taken from the inside of the container being sealed.

As it was mentioned before, the wall of a reservoir on a highway tanker has a relatively thin wall, and a breach in this reservoir has sharp points 82 and narrow crevices 84. When a bladder 66 is inflated in this hole 80 the material of the bladder must be able to slide over the sharp points 82 without catching and tearing. The material of the bladder must be able to slide and stretch over the sharp points 82 and to freely deploy to fill the crevices 84.

In order to fulfill these needs and requirements, a preferred material of construction for the bladder 66 is a lamination of multiple layers of polymeric materials, such as MYLAR™ alone or a combination of MYLAR™ and KEVLAR™. Both materials are manufactured by Dupont Inc.

What is claimed is:

1. A spill curtailing tool comprising an elongated extendable frame having;
a first handle mounted to a first end thereof;
a second handle mounted to an intermediate position there along;
a tube mounted to a second end thereof;
said second end being movable toward and away from said first and second handles;
a pair of pressurized instant-foam-producing tanks mounted to said frame; said tanks being connected to said tube for delivering instant foam through said tube;
a folded bladder mounted to said tube for receiving said instant foam therein; and
said tube being angularly movable relative to a plane of said elongated frame.

2. The spill curtailing tool as claimed in claim 1, wherein said bladder is made of laminations of multiple layers of polymeric materials.

3. The spill curtailing tool as claimed in claim 1, further comprising hoses connecting said pressurized foam-producing tanks and said tube.

4. The spill curtailing tool as claimed in claim 3, further comprising a tandem valve mounted along said hoses for selectively opening said hoses.

5. The spill curtailing tool as claimed in claim 4, wherein said tandem valve is mounted to said second handle.

6. The spill curtailing tool as claimed in claim 5, wherein said tandem valve comprises a lever operator.

7. The spill curtailing tool as claimed in claim 6, wherein said second handle is mounted on said intermediate portion in a movable manner along said intermediate portion.

8. The spill curtailing tool as claimed in claim 1, wherein said tube is an elongated tube having spaced-apart holes along a length thereof.

9. The spill curtailing tool as claimed in claim 1, further comprising an angularly movable crosspiece mounted to said second end, and said tube being mounted to said crosspiece.

10. The spill curtailing tool as claimed in claim 9, further comprising a static mixer mounted to said crosspiece and said hoses and said tube being mounted to said static mixer.

11. The spill curtailing tool as claimed in claim 9, further having a pair of depth gauges mounted to said crosspiece on each side of said tube respectively.

12. The spill curtailing tool as claimed in claim 11, wherein said depth gauges are extendable.

13. The spill curtailing tool as claimed in claim 12, wherein said depth gauges are telescopically extendable and are pressure responsive.

14. The spill curtailing tool as claimed in claim 13, wherein said depth gauges are spring loaded.

15. A spill curtailing tool comprising an elongated telescoping frame having;
a first handle mounted to a first end thereof;
a second handle mounted to an intermediate position there along;
a tube mounted to a second end thereof;
said second end being telescopically movable toward and away from said first and second handles;
a pair of pressurized instant-foam producing tanks mounted between said first and second handles; said tanks being connected by hoses to said tube for delivering instant foam through said tube;
a folded bladder mounted to said tube for receiving said instant foam therein;
said tube being angularly movable relative to a plane of said elongated frame;
a tandem valve mounted along said hoses for selectively opening said hoses;
said tandem valve is mounted to said second handle; and
said second handle being mounted on said intermediate portion in a movable manner along said intermediate portion.

16. The spill curtailing tool as claimed in claim 15, wherein said tandem valve comprises a lever operator.

17. A spill curtailing tool comprising an elongated telescoping frame having;
a first handle mounted to a first end thereof;
a second handle mounted to an intermediate position there along;
a tube mounted to a second end thereof;
said second end being telescopically movable toward and away from said first and second handles;
a pair of pressurized instant-foam-producing tanks mounted between said first and second handles; said tanks being connected by hoses to said tube for delivering instant foam through said tube;
a folded bladder mounted to said tube for receiving said instant foam therein;
said tube being angularly movable relative to a plane of said elongated frame;
a tandem valve mounted along said hoses for selectively opening said hoses;
said tandem valve being mounted to said second handle;
said tube having an elongated hollow cylindrical shape and spaced-apart holes along a length thereof; and
said frame further comprising an angularly movable crosspiece mounted to said second end, and said tube being mounted to said crosspiece.

18. The spill curtailing tool as claimed in claim 17, further comprising a static foam-mixing chamber mounted to said crosspiece and said hoses and said tube being mounted to said static foam-mixing chamber.

19. The spill curtailing tool as claimed in claim 17, further having a pair of depth gauges mounted to said crosspiece on each side of said tube respectively.

20. The spill curtailing tool as claimed in claim 19, wherein said depth gauges being telescopically extendable and spring loaded.
